(19) United States
(12) Patent Application Publication
(10) Pub. No.: US 2009/0173809 A1
(43) Pub. Date: Jul. 9, 2009

(54) SPRAY GUN SPLITTER

(75) Inventor: TIAO-HSIANG HUANG, TAIPEI HSIEN (TW)

Correspondence Address: ROSENBERG, KLEIN & LEE, 3458 ELLICOTT CENTER DRIVE-SUITE 101, ELLICOTT CITY, MD, 21043, US

(73) Assignee: KUAN CHANG CO., LTD., TAIPEI COUNTY (TW)

(21) Appl. No.: 11/969,472

(22) Filed: Jan. 4, 2008

(51) Int. Cl. B05B 15/00

(52) U.S. Cl. 239/418

(57) ABSTRACT

A spray gun splitter is a slice having two opposite sides. Flanges provided on the two sides form an inner ring and an outer ring on each side, and there are interpenetrated troughs equally positioned along the inner ring and the outer ring. Through the inner ring and the outer ring of the splitter combining with the corresponding modules of the spray gun, a separate of two independent gas flows is free of turbulence which further effectively controls over the uniformity and the area of the spraying paint.

### BACKGROUND OF THE INVENTION

1. Field of the Invention

The present invention relates generally to a spray gun splitter structure, and more particularly, to a splitter which is provided with flanges tightly attached to the spray gun, disabling the split gases into turbulence.

2. Description of the Prior Art

Spray guns are a tool that features efficiency, economy and handiness, which facilitates the promptness and easiness of the spraying work with all kinds of paints. FIGS. 4-5 show a splitter F of a conventional spray gun E is provided with a convex cylinder F1 which is located at the top of the spray gun E. When in usage, high pressure gas buffered in the spray gun E flows out of two canals E3, E4 of the two curved recesses E1, E2 at the front side of the gun head, through two opposite cavities F2, F3 of the splitter F. The splitter F helps in stabilizing the gas pressure. The gas proceeds to flow through the splits of a trough F4 of the inner side and a trough F5 of the outer side, to an inner groove G1 and an outer groove G2 at the back side of a joint G. FIG. 4 shows the side view of the gas flows through the inner ring. FIG. 5 shows the side view of the gas flows through the outer ring. The splitter F is a slice, with plans at its both sides, and associates with a gas hole of the joint G, which is not available to form a sealed chamber. The interflowing of gas easily results in turbulence that would fail to have effective control of the area of spraying paint. The splitter F demands the convex cylinder F1 at the top of the spray gun E. A care is required for the positions in correspondence during assembly which is time consuming.

### SUMMARY OF THE INVENTION

The objective of the present invention is to provide a spray gun splitter that disposes of the problems of possible interflows to result in turbulence that in turn acts on the area of the spraying paint.

According to the present invention, there is provided a spray gun splitter, which is a slice having opposite sides, and there are flanges on the two sides to form an inner ring and an outer ring each, wherein the inner ring has a gas chamber as its height. There are interpenetrated troughs equally positioned along the inner ring and the outer ring.

Preferably, the troughs in the inner ring are interlaced with the troughs in the outer ring.

The advantages of the present invention are as follows:
1. The gas chambers formed by the flanges of the two opposite sides of the splitter are stuck closely with the associated module of the spray gun into sealed gas chambers, which enables the gases exclusively flow in the inner ring and the outer ring respectively and disables the turbulence of them, to precisely control the uniformity and the area of the spraying paint.
2. The splitter is installed directly on the spray head, free of the setup for the convex cylinder, easy of installation.

### BRIEF DESCRIPTION OF THE DRAWINGS

FIG. 1 is a perspective view of the present invention;

FIG. 2 is a cross-sectional view of the present invention coupled to a spray head;

FIG. 3 is a cross-sectional view showing the gas flows of the present invention;

FIG. 4 is a first cross-sectional view showing the side view of the gas flows in the inner ring of the prior art; and

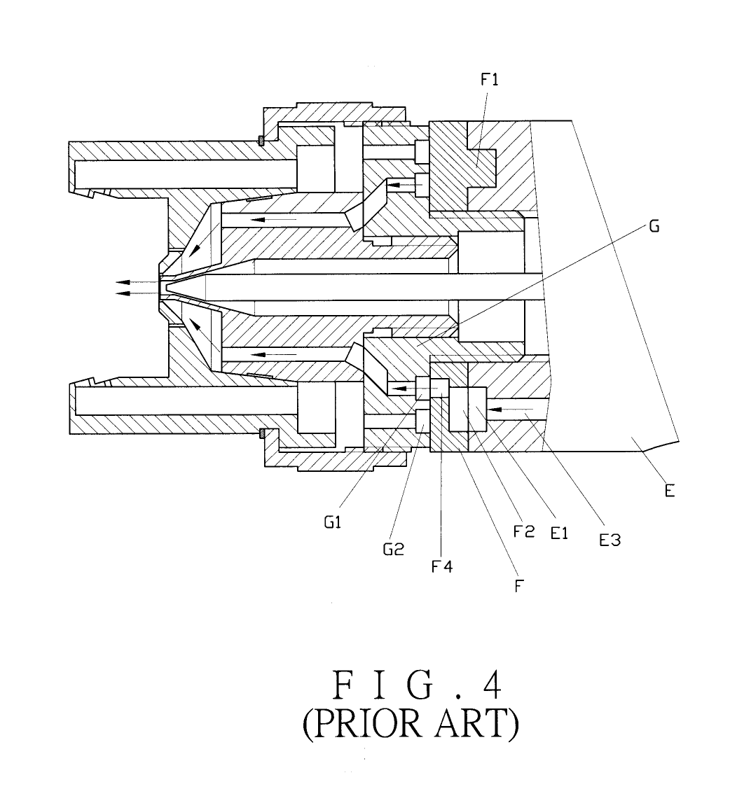

FIG. 5 is a second cross-sectional view showing the side view of the gas flows in the outer ring of the prior art.

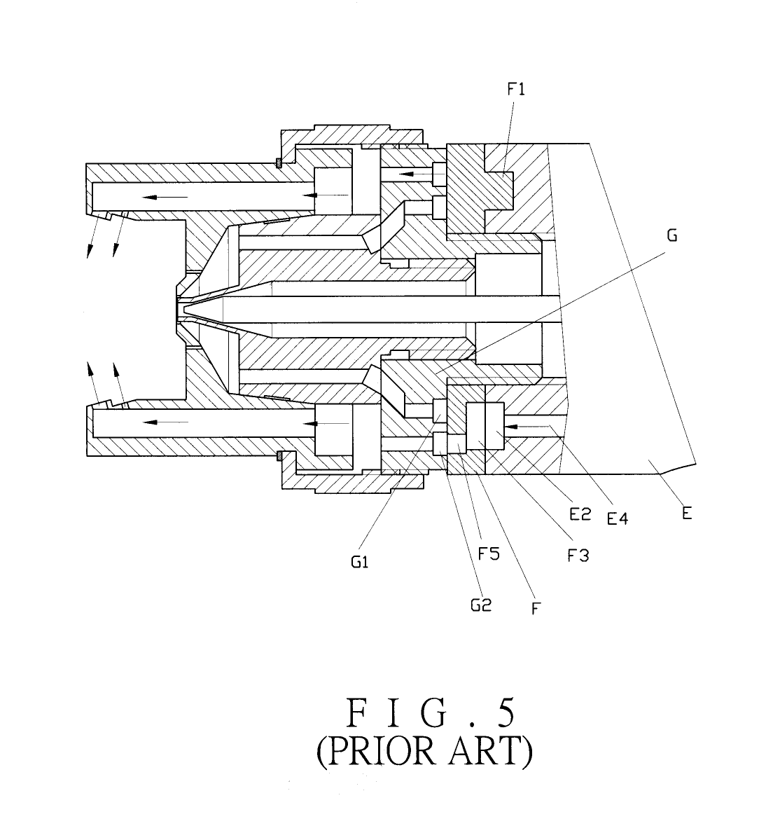

### DETAILED DESCRIPTION OF THE PREFERRED EMBODIMENT

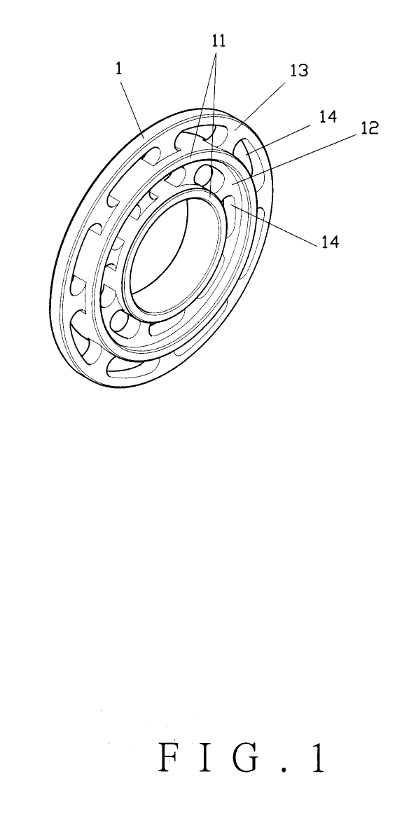

The splitter 1 of the present invention, shown in FIG. 1, is a slice having two opposite sides, and there are flanges 11 on the two sides to form an inner ring 12 and an outer ring 13 each. The inner ring 12 has a gas chamber as its height. There are interpenetrated troughs 14 equally positioned along the inner ring 12 and the outer ring 14, and the troughs 14 in the inner ring 12 are interlaced with the troughs 14 in the outer ring 14.

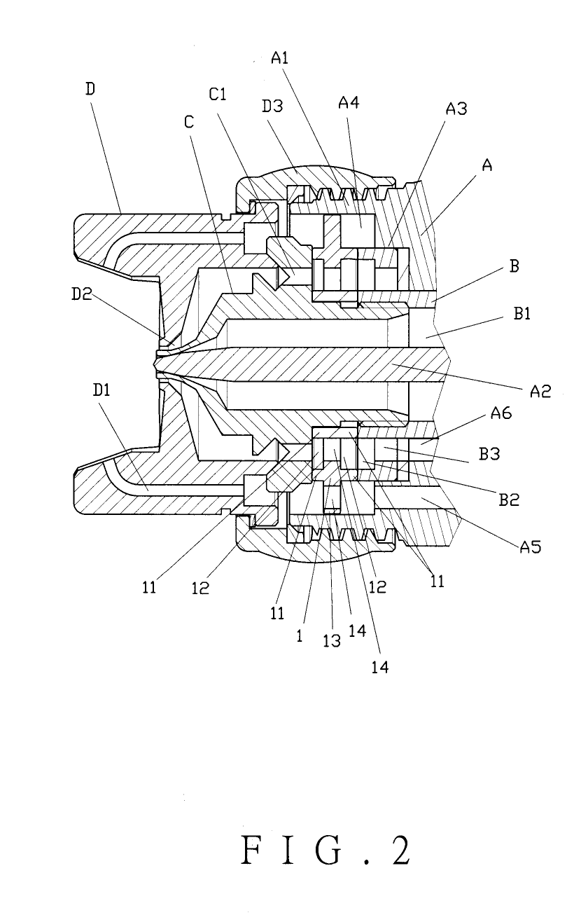

During assembly, shown in FIG. 2, a spray head A1 of a spray gun A has an adjusting pin A2 therein, which forms an inner groove A3 and an outer groove A4/The outer groove A4 is provided with a first gas canal A5 and a second gas canal A6. The inner groove A3 of the spray gun A is provided with a joint B. The joint B has a tube B1 which has a first annular notch B2 at its end. The first annular notch B2 is provided with a third gas canal B3 corresponding to the second gas canal A6. The splitter 1, located in the outer groove A4 of the spray head A1, has its flanges 11 on its one side stuck to the side of the joint B which is associated with the first annular notch B2. The space in the inner ring 12 of the splitter 1 combines with the first annular notch B2 to form a sealed gas chamber. A nozzle C is screwed to the front end of the joint B. The side of the nozzle C is stuck to the flanges 11 of the other side of the splitter 1. The side of the nozzle C is provided annularly with a plurality of gas holes C1 which join the troughs 14 along the inner ring 12 of the splitter 1 and the third gas canal B3 of the first annular notch B2 of the joint B. A sprinkler D is set up in the circular dented portion in front of the nozzle C. A blow hole D1 is set up external to the sprinkler D. The blow hole D1 joins the troughs 14 along the outer ring 13 of the splitter 1 and the first gas canal A5 of the outer groove A4 of the spray head A1. An orifice D2 is formed in the center of the circular hollow of the sprinkler D which is fastened by a nut D3 to the spray head A1.

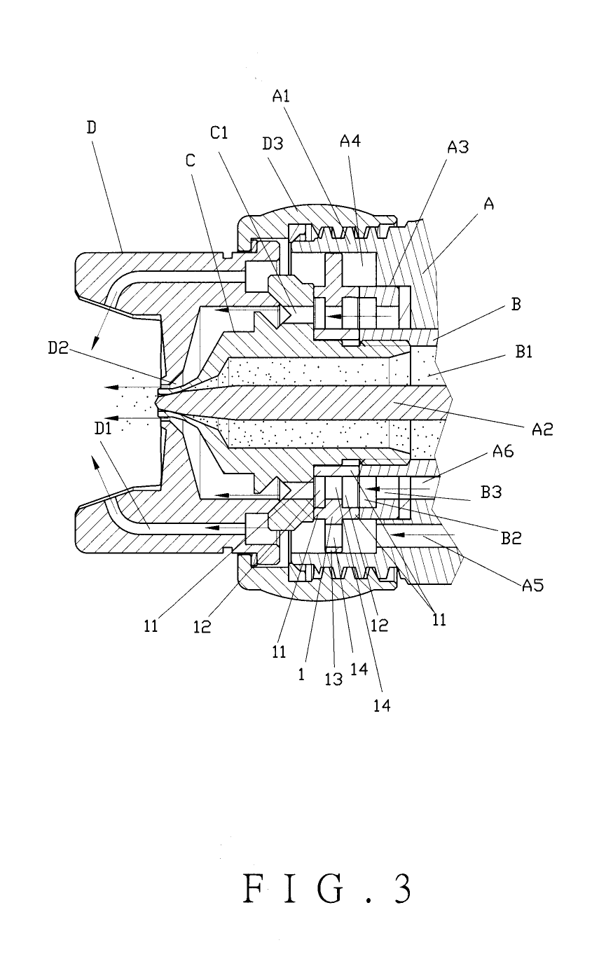

During usage, shown in FIG. 3, high pressure gas inputted in the spray gun A flows out of the first gas canal A5 and the second gas canal A6 of the spray gun A and the third gas canal B3 of the joint B, to the troughs 14 along the inner ring 12 and the troughs 14 along the outer ring 13 of the splitter 1. The gas flowed from the troughs 14 flows through the gas hole C1 of the nozzle C to the orifice D2. The gas flowed from the opposite troughs 14 are sprayed by the blow hole D1 of the sprinkler D for better control over the area of the paint. The flanges 11 on the both sides of the splitter 1 are stuck tightly to the side of the joint B and the side of the nozzle C, respectively. Since the gas chamber in the inner ring 12 of the splitter 1 is formed a sealed one by combining with the first annular notch B2, the gas flows in the inner ring 12 and the outer ring 13 are separate flows which will not be turbulent. The troughs 14 help in stabilizing the gas in the precise control over the uniformity and the area of the spraying paint.

What is claimed is:

1. A spray gun splitter being a slice having two opposite sides, and having flanges thereon to form an inner ring and an outer ring each, wherein the inner ring has a gas chamber as its height, wherein the inner ring and the outer ring are formed with interpenetrated troughs equally positioned along the inner ring and the outer ring.

2. The spray gun splitter as in claim 1, wherein the troughs in the inner ring and the troughs in the outer ring are interlaced with each other.
